(19) United States
(12) Patent Application Publication
(10) Pub. No.: US 2026/0135048 A1
(43) Pub. Date: May 14, 2026

(54) MANUAL OPERATION ASSEMBLY

(71) Applicant: NOJA POWER SWITCHGEAR PTY LTD, Murarrie, Queensland (AU)

(72) Inventors: Joni TORTIAN, Murarrie, Queensland (AU); Mariano ORTEGA, Murarrie, Queensland (AU); Angelica Maree VIGAR, Murarrie, Queensland (AU); David DART, Murarrie, Queensland (AU); Mark Ashley GILROY, Murarrie, Queensland (AU); Joshua David KEMP, Murarrie, Queensland (AU)

(21) Appl. No.: 19/120,089

(22) PCT Filed: Oct. 10, 2023
(86) PCT No.: PCT/AU2023/050992

§ 371 Date: Apr. 10, 2025

(30) Foreign Application Priority Data
Oct. 10, 2022 (AU) 2022902950

(51) Int. Cl. H01H 9/20

(52) U.S. Cl. CPC H01H 9/20

(57) ABSTRACT

A manual operation assembly for preventing access to an anchor point of a recloser for removing/installing a recloser until presenting an open circuit, the manual operation assembly comprising at least one anchor point associated with the recloser for receiving a tool for installation and/or removal of the recloser from a fuse holder; a lever operable between an open position and a closed position, the lever comprising one or more longitudinally extending members configured for operably engaging with a mechanical reclosing mechanism of the recloser; and the mechanical reclosing mechanism being responsive to movement of the lever for causing the recloser to present the open circuit upon the lever moving to the open position; wherein the at least one anchor point for removal or installation of the recloser into the fuse holder is inaccessible to the tool until the lever is in the open position causing the recloser to present in an open circuit.

### TECHNICAL FIELD

The present invention relates to a manual operation assembly for preventing installation and/or removal of a recloser.

### BACKGROUND

Any references to methods, apparatus or documents of the prior art are not to be taken as constituting any evidence or admission that they formed, or form part of the common general knowledge.

Electrical distribution network works are particularly dangerous. Workers encounter among other things, high voltages and working at heights. Ensuring the equipment is properly maintained and installed as well as being able to safely engage with the equipment as needed is key to ensuring that accidents are reduced and/or eliminated.

Workplace health and safety is a continuously improving process which seeks to ensure the safety of workers in all fields. As such, solutions which can provide a barrier to injury, especially in risky areas such as electrical work, are sought as a matter of good practice.

### SUMMARY OF INVENTION

In an aspect, the invention provides a manual operation assembly for preventing access to an anchor point of a recloser for removing/installing a recloser until presenting an open circuit with a lever in an open position, the manual operation assembly comprising:

at least one anchor point associated with the recloser for receiving a tool for installation and/or removal of the recloser from a fuse holder;

the lever operable between the open position and a closed position, the lever comprising one or more longitudinally extending members configured for operably engaging with a mechanical reclosing mechanism of the recloser; and

the mechanical reclosing mechanism being responsive to movement of the lever for causing the recloser to present the open circuit upon the lever moving to the open position;

wherein the at least one anchor point for removal or installation of the recloser into the fuse holder is inaccessible to the tool until the lever is in the open position causing the recloser to present in an open circuit.

In an embodiment, the lever comprises an interlock plate.

In an embodiment, the at least one anchor comprises an aperture for receiving a tool for removal and/or installation of the recloser into the fuse holder.

In an embodiment, the interlock plate defines a recess for receiving the at least one anchor.

In an embodiment, the interlock plate prevents access to the at least one anchor by the tool when the recess has received the at least one anchor.

In an embodiment, the lever comprises two longitudinally extending members.

In an embodiment, the two longitudinally extending members are positioned on opposing sides of the interlock plate.

In an embodiment, the two longitudinally extending members comprise openings for receiving respective shaft ends of the mechanical reclosing mechanism.

In an embodiment, the openings of the longitudinally extending members are coaxial.

In an embodiment, the openings engage with respective shaft ends of the mechanical reclosing mechanism to transmit torque thereto.

In an embodiment, the lever rotates about an axis directed through the coaxial openings of the longitudinally extending members.

In an embodiment, the at least one anchor is located on an external surface of the recloser.

In an embodiment, the lever comprises an aperture for receiving the tool for moving the lever between an open position and closed position.

According to a further embodiment of the present invention there is provided a manual operation assembly for a recloser including a lever pivotably attachable to an internal recloser mechanism of the recloser and an anchor mountable to the recloser wherein the anchor is inaccessible by a tool for removing/installing a recloser unless the lever is in a position for maintaining the recloser in an open circuit configuration.

According to another aspect of the present invention there is provided a method for manually operating a recloser having an internal recloser mechanism responsive to torque for causing the recloser to assume an open circuit configuration prior to removing a recloser or a portion thereof from a fuse holder before causing the recloser to assume a closed circuit configuration, the method comprising:

providing a recloser installed in a fuse holder of a distribution line, the recloser having an anchor point inaccessible to a tool for engaging with the anchor point for removing the recloser or a portion thereof from the fuse holder;

operating a lever to apply torque to the internal recloser mechanism to thereby exposing an anchor point and cause the recloser to assume the open circuit configuration;

Engaging the anchor point with the tool; and

applying a force to the anchor point and manoeuvring the tool to remove the recloser or a portion thereof from the fuse holder.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a side view of a manual operation assembly according to an embodiment of the present invention shown in use attached to a recloser.

FIG. 2 is an isometric view of the lever of FIG. 1.

FIG. 3 is an isometric view of the interlock plate of FIG. 1.

FIG. 4 is an isometric view of the anchor of FIG. 1 without the lever.

FIG. 5 is a cross section of the recloser of FIG. 1.

### DETAILED DESCRIPTION OF PREFERRED EMBODIMENTS

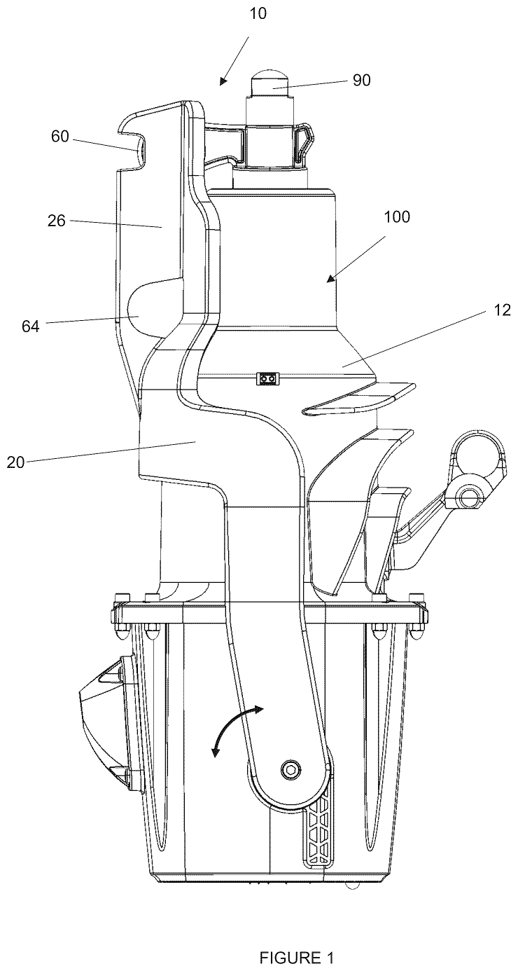

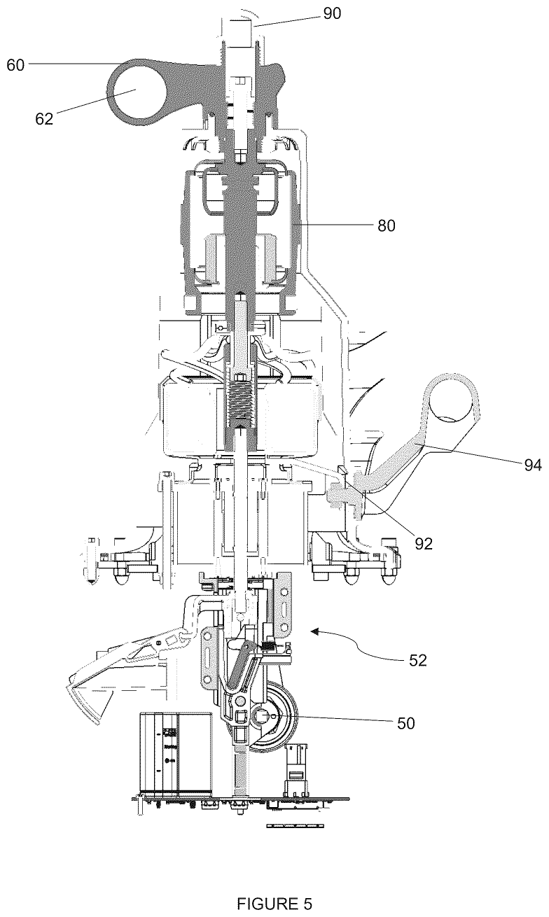

FIG. 1 illustrates a manual operation assembly 10 according to the preferred embodiment of the present invention shown in use with a recloser 100. In the presently described preferred embodiment the manual operation assembly 10 comprises a lever 20 and an anchor 60 (best seen in FIG. 4). The manual operation assembly 10 is preferably used in switchgear applications for manually operating a switchgear, such as recloser 100, which is configured to present an open circuit configuration or a closed circuit configuration to distribution line current therethrough. The lever 20 is operable to move between an open position and a closed position, the closed position is shown in FIG. 1, to actuate a mechanical recloser mechanism 52 (FIG. 5) of recloser 100. The mechanical recloser mechanism 52 is configured to in turn cause an internal dielectric vacuum interrupter 80 to interrupt the distribution line current in a distribution line to thereby present the open circuit. Referring to FIG. 5, whilst lever 20 is in the closed position shown in FIG. 1, distribution line current flows through the recloser 100 from a fuse tip 90, through the dielectric vacuum current interrupter 80 and out through the bus bar 92 and/or the trunnion 94. The present invention provides a manual operation assembly, which in a preferred embodiment is in the form of manual operation assembly 10, for manually operating the recloser 100 so as to interrupt the flow of distribution line current through the recloser 100.

Actuation of the mechanical recloser mechanism 52 causes a disruption in the distribution line current flowing through the recloser 10. For example, moving the lever 20 to from the closed position shown in FIG. 1 to an open position, causes the recloser 100 to present an open circuit thereby disrupting the flow of distribution line current in a distribution line. In instances where the manual operation assembly 10 is coupled with a mechanical reclosing mechanism and/or an electromechanical reclosing mechanism, the mechanical reclosing mechanism and/or the electromechanical reclosing mechanism may disrupt the flow of distribution line current in the distribution line while the lever 20 is in the closed position (as seen in FIG. 1). In such instance, the recloser 100 may present a closed circuit either by remotely activating the mechanical reclosing mechanism and/or electromechanical reclosing mechanism. Alternatively, the recloser 100 may be presented in the closed position by moving the lever 20 to an open position and then back to the closed position. In the preferred embodiment, the lever 20 is configured to cause the recloser 100 to present an open circuit when the lever assumes an open position, being a position when the lever 20 is not substantially in the closed position shown in FIG. 1. Such an arrangement is advantageous in that it ensures that the recloser 100 must be installed correctly prior to allowing distribution line current flow therethrough. This may assist in preventing electric arc prior to being fully installed thereby avoiding injuries to workers and/or to equipment.

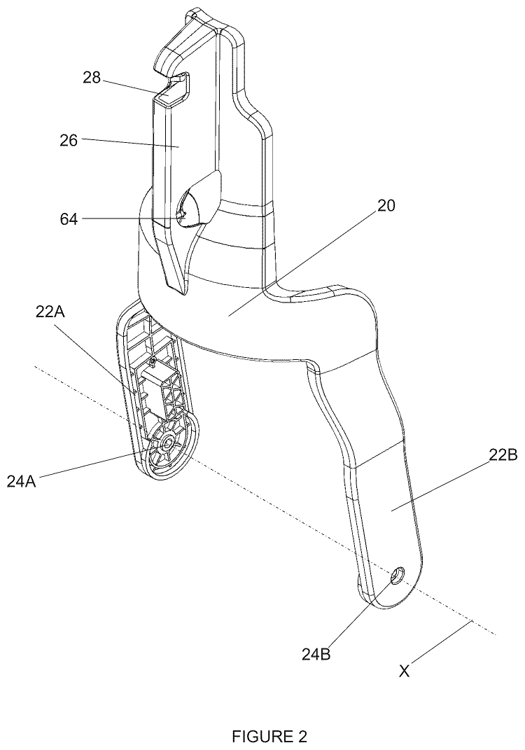

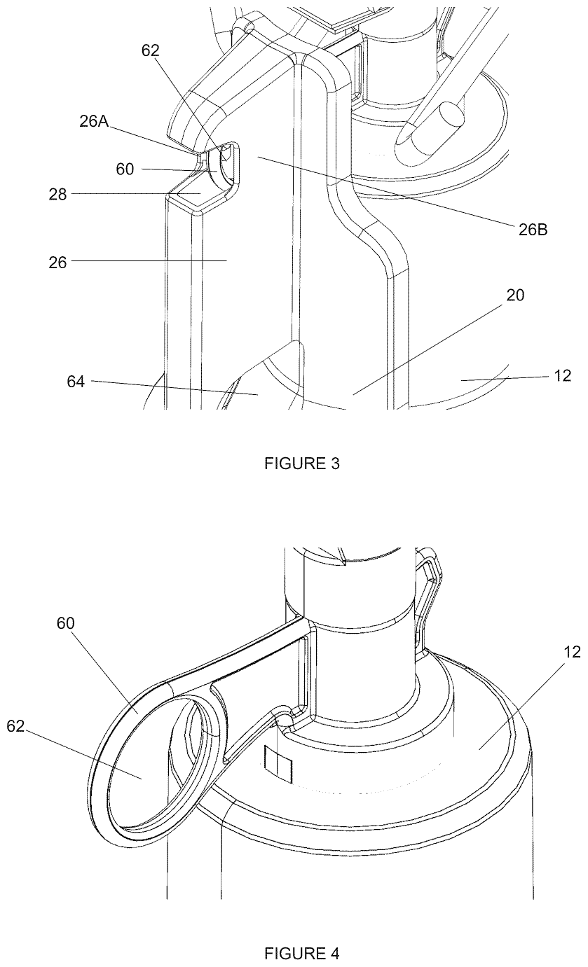

The lever 20 operates by rotation about an axis X (FIG. 2). In the preferred embodiment, the lever 20 rotates approximately 90° between the open and the closed position. However, the person skilled in the art would appreciate that the degree of rotation of the lever 20 between the open position and the closed position is subject to particular arrangement of the recloser mechanism 52, which causes the vacuum interrupter 80 to disrupt the flow of distribution line current.

As shown in FIG. 2, the lever 20 of the presently described preferred (but non-limiting) example, comprises two longitudinally extending members 22A, 22B. In the presently described embodiment the longitudinally extending members 22A, 22B are configured to receive the recloser body 12 or at least a portion thereof insofar as the first longitudinally extending member 22A and the second longitudinally extending member 22B are operably positioned on opposite sides of recloser 100. Each of the longitudinally extending members 22A, 22B of the lever 20 respectively comprises an opening 24A, 24B. In the preferred embodiment, the openings 24A, 24B are coaxial with axis X. The openings 24A, 24B provide a point for operably engaging the longitudinally extending members 22A, 22B of the lever 20 with shaft ends of a rotatable shaft 50 of the mechanical reclosing mechanism of the recloser 10. The manner in which the rotatable shaft ends 50 may be rigidly affixed to the openings 24A, 24B, comprises but is not limited to, one or more splines, complementary interfaces which support the transfer of torque (i.e. square cross section), screws, fasteners, welding and/or an adhesive. As can be seen in FIG. 5, the rotatable shaft ends 50 comprise a square cross section which is received in a complementary profile of the openings 24A, 24B.

The person skilled in the art would readily appreciate that the openings 24A, 24B may extend to a number of different connection type. For example, the rotatable shafts 50 may further comprise a torque member extending orthogonal to the axis X of rotation wherein the lever 20 may receive the torque member or a portion thereof to provide a connection for efficiently applying torque to the torque member to operate the mechanical reclosing mechanism 52.

In the preferred embodiment, the lever 20 of the manual operation assembly 10 comprises an interlock plate 26. The interlock plate 26 extends between the longitudinally extending members 22A, 22B. The interlock plate 26 and longitudinally extending members 22A, 22B may form a profile for receiving and abutting the recloser 100. The interlock plate 26 in combination with the lever 20 are configured such that when the lever 20 is in the closed position (as seen in FIG. 1), the anchor 60 is inaccessible to a tool, such as a hot stick or hook stick, for installing/removing the recloser 100. Accordingly, the lever 20 must be rotated towards the open position, wherein the vacuum interrupter is in the open circuit, prior to exposing the anchor 60 for engagement with the tool for removal and/or installation. Such an assembly ensures that the recloser 100 is only removed or installed when the distribution line current is not and cannot flow through the recloser 100. This provides safety against electric arc. It is only once installed or removed and the lever 20 is moved or rotated into the closed position that the current in the distribution line can flow freely.

In the preferred embodiment, the interlock plate 26 is configured with a recess 28 for receiving an anchor 60. The anchor 60 is fastened or otherwise rigidly affixed relative to the recloser 100. In the preferred embodiment, the anchor 60 is located on an external surface of the recloser 100. In the preferred embodiment, the anchor 60 comprises an aperture 62. The aperture 62 provides a structure for the tool to engage with and receive. When exposed, the tool can engage the anchor 60 through the aperture 62 and by applying a force in the appropriate direction, a user can manoeuvre the recloser 100 into position for installation and/or removal from the fuse holder of a distribution line.

Referring to FIG. 5 generally, the lever 20 actuates the rotatable shaft 50 of the mechanical recloser mechanism 52 through rotation. The rotatable shaft 50 may be used to open/close the current interrupter, such as the dielectric vacuum current interrupter 80. The person skilled in the art would appreciate that there are various switchgears which may operate in varying manners which the present invention may provide further utility.

Throughout the specification a tool is referenced for engaging with the anchor 60, preferably through aperture 62. The tool may also be configured to operate the lever 20. The lever 20 preferably comprises a second aperture 64. Wherein the second aperture 64 is configured to receive the tool so as to move the lever 20 between the open position and the closed position. Accordingly, the same tool is suitable for moving the lever 20 between the open and closed position as well as for removing and/or installing the recloser 100 into the fuse holder. The tool being referred to is typically referred to as a hot stick or a hook stick. The hook stick comprises a hook portion on its end so as so substantially couple an end of the stick to the recloser 100. The hook stick generally has a substantially elongate body for gripping and manoeuvring by a worker. Accordingly, the majority of the substantially elongate body is isolated from the hook portion of the hook stick. The hook stick provides a worker with the ability to work at a safe distance from electrical lines, in particular high voltage electrical lines, for safety reasons. The manual operation assembly 10 advantageously provides an additional layer of safety in an already high-risk dangerous industry.

Throughout the specification there are mentions of installing and/or removing the recloser 100 from the fuse holder. The recloser 100 is typically installed between two contact points (i.e. the fuse tip 90 and a trunnion or bus bar). Accordingly, removing or removal of the recloser 100 from the fuse holder may refer to merely dislodging the fuse tip from its respective contact point of the fuse holder. Conversely, installing or installation may refer to lodging the fuse tip 90 into its respective contact point of the fuse holder. Therefore, installing and removal does not necessarily require separation of the recloser 100 from the fuse holder entirely. As such, the recloser 100 may be removed from the fuse holder and still be in connection with and/or supported by the trunnion or the bus bar.

The method of use will now be described with reference to the Figures generally.

To use manual operation assembly 10, once attached to recloser 100 as shown in the Figures, the lever 20 will be rotated to the open position to expose the anchor 60 for engagement by the tool. Once the tool is engaged with the anchor 60, preferably by hooking the anchor 62 through the aperture 60, the worker can manoeuvre the recloser 100 into position in an existing fuse holder (not shown) of the distribution line. Preferably, the lever 20 will be substantially perpendicular to the recloser body 12. Once installed, the worker may then rotate the lever 20 towards the recloser body 12 such that the lever 20 receives and abuts the recloser body 12 or a portion thereof.

In the embodiment illustrated herein, the lever 20 moves towards the closed position, the interlock plate 26 receives anchor 60 within the recess 28 defined by the interlock plate 26, as shown in FIG. 1. The interlock plate comprises opposing wall portions 26A, 26B extending parallel to the recess 28 for receiving the anchor 60. The opposing wall portions 26A, 26B of the interlock plate 26 extend sufficiently to receive and to shroud the exposed anchor 60 or portion of the anchor 60 and aperture 62 or portion of the aperture 62 such that the tool cannot be inserted through the aperture 62. The recloser 100 may present an open circuit to the distribution line until the lever 20 substantially abuts and receives the recloser body 12 receiving the anchor 60 within the recess 28. In this manner, the recloser 100 is prevented from being or attempting to be installed and/or removed unless the recloser is actuated into the open position. An authorised worker may utilise a specifically designed tool for installing and/or removing the recloser 100. However, said tool may not be used for said purposes by a worker or another party unless the current flowing through the recloser is interrupted 100.

It will be realised that in other embodiments the lever 20 of the manual operation assembly 10 may be comprised of only a single elongate member and/or the lever may be concave toward the recloser so that only an upper portion of the lever, such as the interlock plate 26 is brought adjacent the anchor 60 without necessarily abutting the recloser body 12. Whilst in the preferred embodiment of the invention the manual operation assembly 10 includes a lever 20 and anchor 60 as particularly illustrated, in further embodiments a discrete anchor may not be provided. For example, the anchor may be integrally formed with recloser body 12 or another portion of the recloser 100.

It will further be realised that a method has been described for manually operating a recloser 100 that has an internal recloser mechanism, such as internal mechanism 52, which is responsive to torque and which is configured to cause the recloser 100 to assume an open circuit or a closed circuit configuration. In an embodiment the method involves operating a lever to apply torque to the internal mechanism to thereby cause the recloser to assume the closed circuit configuration. Access to the anchor 60 can then be prevented, e.g., the position shown in FIG. 1, upon the closed circuit configuration being assumed to thereby maintain the closed circuit configuration.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A manual operation assembly for preventing access to an anchor point of a recloser for removing/installing a recloser until presenting an open circuit with a lever being in an open position, the manual operation assembly comprising:
at least one anchor point associated with the recloser for receiving a tool for installation and/or removal of the recloser from a fuse holder;
the lever operable between the open position and a closed position, the lever comprising one or more longitudinally extending members configured for operably engaging with a mechanical reclosing mechanism of the recloser; and
the mechanical reclosing mechanism being responsive to movement of the lever for causing the recloser to present the open circuit upon the lever moving to the open position;
wherein the at least one anchor point for removal or installation of the recloser into the fuse holder is inaccessible to the tool until the lever is in the open position causing the recloser to present in an open circuit.

2. The manual operation assembly according to claim 1, wherein the lever comprises an interlock plate.

3. The manual operation assembly according to claim 1, wherein the at least one anchor comprises an aperture for receiving a tool for removal and/or installation of the recloser.

4. The manual operation assembly according to claim 2, wherein the interlock plate defines a recess for receiving the at least one anchor.

5. The manual operation assembly according to claim 2, wherein the interlock plate prevents access to the at least one anchor by the tool when the recess has received the at least one anchor.

6. The manual operation assembly according to claim 2, wherein the lever comprises two longitudinally extending members.

7. The manual operation assembly according to claim 6, wherein the two longitudinally extending members are positioned on opposing sides of the interlock plate.

8. The manual operation assembly according to claim 6, wherein the two longitudinally extending members comprise openings for receiving respective shaft ends of the mechanical reclosing mechanism.

9. The manual operation assembly according to claim 8, wherein the openings of the longitudinally extending members are coaxial.

10. The manual operation assembly according to claim 8, wherein the openings engage with respective shaft ends of the mechanical reclosing mechanism to transmit torque thereto.

11. The manual operation assembly according to claim 8, wherein the lever rotates about an axis directed through the coaxial openings of the longitudinally extending members.

12. The manual operation assembly according to claim 1, wherein the at least one anchor is located on an external surface of the recloser.

13. The manual operation assembly according to claim 1, wherein the lever comprises an aperture for receiving the tool for moving the lever between an open position and closed position.

14. A method for manually operating a recloser having an internal recloser mechanism responsive to torque for causing the recloser to assume an open circuit configuration prior to removing a recloser or a portion thereof from a fuse holder before causing the recloser to assume a closed circuit configuration, the method comprising:
providing a recloser installed in a fuse holder of a distribution line, the recloser having an anchor point inaccessible to a tool for engaging with the anchor point for removing the recloser or a portion thereof from the fuse holder;
operating a lever to apply torque to the internal recloser mechanism to thereby exposing an anchor point and cause the recloser to assume the open circuit configuration;
engaging the anchor point with the tool; and
applying a force to the anchor point and manoeuvring the tool to remove the recloser or a portion thereof from the fuse holder.
